(19) United States
(12) Patent Application Publication
(10) Pub. No.: US 2015/0140309 A1
(43) Pub. Date: May 21, 2015

(54) Process and Apparatus for Embossing Precise Microstructures in Rigid Thermoplastic Panels

(71) Applicant: 10x Technology LLC, Libertyville, IL (US)

(72) Inventor: Robert M. Pricone, Libertyville, IL (US)

(21) Appl. No.: 14/400,503

(22) PCT Filed: Mar. 15, 2013
(86) PCT No.: PCT/US13/31918

§ 371 Date: Nov. 11, 2014

Related U.S. Application Data
(60) Provisional application No. 61/646,027, filed on May 11, 2012.

(51) Int. Cl. B29C 59/04; B29C 59/02; B32B 33/00

(52) U.S. Cl. CPC B29C 59/04; B32B 33/00; B29C 59/022; B32B 2590/00; B29C 2059/023; B29K 2101/12
USPC 428/220; 264/284; 264/259; 425/371

(57) ABSTRACT

A process and apparatus for embossing relatively rigid polymeric panels having precise microstructured surfaces on at least one face of the panel including using a continuous press having upper and lower belts; providing tools with the embossing pattern(s); feeding the tools and panels juxtaposed thereon through the press where heat and pressure are applied to form the em bossed precise microstructured surface and cooling the embossed panel, all while maintaining pressure on the panel and the tool, and thereafter separating the embossed polymeric panel from the tool.

This application claims the benefit of provisional application Ser. No. 61/646,027 filed May 11, 2012.

### RELATED APPLICATIONS

This application relates to significant improvements to the method and apparatus of prior patent, U.S. Pat. No. 6,908,295, issued Jun. 21, 2005, of which the current inventor is a named co-inventor thereof.

### BACKGROUND OF THE INVENTION

1. Technical Field

The present invention relates to a process and apparatus for embossing material with precise detail, and more particularly, to a process and apparatus for making relatively rigid panel products of thermoplastic material having surfaces with precision microstructures, as defined below.

2. Background Art

Processes and apparatus for embossing precision optical patterns such as microcubes, in a thin film resinous sheet or laminate, are well known, as referenced in U.S. Pat. Nos. 4,486,363; 4,478,769; 4,601,861; 5,213,872; 6,015,214, and more recently U.S. Pat. No. 6,908,295, which patents are all incorporated herein by reference. In the production of such synthetic resin optical sheeting film, highly precise embossing (generally exceeding the capabilities of the current micromolding processing techniques for synthetic resins, is required because the geometric accuracy of the optical elements determines its optical performance. The above referenced patents disclose in particular methods and apparatus for continuously embossing a repeating retro-reflective cube-corner pattern of fine or precise detail on one surface of a transparent and thin thermoplastic film to form the surface of the film into the desired microstructure pattern.

However, besides precision optical retro-reflective sheeting, various other applications have been envisioned which would be highly enhanced by the formation of highly precise shapes and structures in resinous relatively rigid panels. Currently, for example, in the manufacture of road signs the processed cube-corner thin film is normally adhered to an underlying metal or other rigid substrate, so that the laminated panel has enough structural integrity to be mounted as a road sign. One proposed alternative to traditional reflective sheeting can be accomplished by embossing similar cube-corner structures directly on a polymeric rigid sheet at least 2.5 mm or thicker. Other applications include solar panels in which an array of Fresnel type lenses are continuously formed in a thin film and then laminated to a rigid transparent polymer substrate. Such applications require the embossing of thin thermoplastic material film to provide the precisely formed and spaced functional geometric elements, or arrays of such functional geometric elements on the film surface. In the case of solar panels, not only must the lens element be optically accurate to focus light on the target area for energy conversion, but the spacing of the lens elements relative to each other also is of critical importance to achieve the necessary efficiency of light directed to the receiving energy converting junction.

These geometric elements, or precision microstructures, are defined by any or all of the following characteristics: precise embossing depths; flat surfaces with precise angular orientation; fine surface smoothness; sharp angular features with a very small radius of curvature; and precise dimensions of the elements and/or precise separation of the elements, within the plane of the film. The precise nature of the formed surface is critical to the functional attributes of the formed products, whether used for microcubes or other optical features such as the radial Fresnel lenses in solar panels; or as light directing or diffusing panels for lighting fixtures; or as channels for microfluidics, or in fuel cells; or for accurate dimensions, flatness and spacing when providing a surface for holding nanoblocks in Fluidic Self Assembly (FSA) techniques; or imparting a microtextured surface that is not optically smooth within an array that includes, or excludes additional microarchitecture.

U.S. patents describing some uses of precise microstructures include: U.S. Pat. Nos. 4,486,363; 6,015,214 (microcubes); U.S. Pat. Nos. 5,783,856; 6,238,538 (microfluidics); and U.S. Pat. No. 6,274,508 (FSA).

As described in some of the above mentioned patents, such as U.S. Pat. Nos. 4,486,363, 4,601,861, and 4,478,769, embossed microstructure film may be made on a machine that includes two supply reels, one containing an unprocessed film of thermoplastic material, such as acrylic or polycarbonate, or even vinyl, and the other containing a transparent and optically smooth plastic carrier film such as PET (trade name Mylar), which should not melt or degrade during the embossing process. These films are fed to and pressed against a heated embossing tool in the form of a thin endless flexible metal belt. The belt creates the desired embossed pattern on one surface of the thermoplastic film, and the carrier film makes the other surface of the thermoplastic film optically smooth.

The belt moves around two rollers, which advance the belt at a predetermined linear controlled speed or rate. One of the rollers is heated and the other roller is cooled. An additional cooling station, e.g. one that blows cool air, may be provided between the two rollers. Pressure rollers are arranged about a portion of the circumference of the heated roller. Embossing occurs on the web as it and the continuous tool pass around the heated roller while pressure is applied by one or more pressure rollers, causing the film to be melted and pressed onto the tool. The embossed film (which may have been laminated to other films during the embossing process), is cooled, monitored for quality and then moved to a storage winder. At some point in the process, the PET carrier film may be stripped away from the embossed film.

The prior apparatus and process work well to produce rolls of film that are effectively 48″ (122 cm) wide (52″/132 cm at selvage), but such equipment and processes have several inherent disadvantages. First, the process speed (and thus the volume of material) is limited by the time needed to heat, mold and “freeze” the film. Also, the pressure surface area and thus the time available to provide adequate pressure by the pressure rollers impose certain special constraints; and then cooling the material is required before separation from the tool. Finally the formation of some embossed surfaces while the tool is in a curved condition requires complex modification of the geometry of the tool surface, because the thermoplastic elements are formed while on a curved surface but generally used later while on a flat surface.

One earlier prior device for forming microcubes while in a planar condition is illustrated in U.S. Pat. No. 4,332,847, and involves indexing of small (9″×9″ or 22.86 cm×22.86 cm) individual molds at a relatively slow speed (See Col. 11, lines 31-68). That process is not commercially practical because of its perceived inability to accurately reproduce microstructures because of indexing mold movement and the relatively small volume (caused by mold size) and speed.

It became apparent that there was a need for equipment and processes that permit a larger volume of precision microstructured material to be produced in a given time, and using tools that may heat, emboss and cool the film while in a planar condition. In this regard, U.S. Pat. No. 6,908,295 developed the technology for embossing thin film in a double band continuous press.

Continuous press machines have been used in certain industries. These machines include double band presses which have continuous flat beds with two endless bands or belts, usually steel, running above and below the product and around pairs of upper and lower drums or rollers. An advantage of such presses is the mainly uniform pressure that can be provided over a large area. These machines form a pressure or reaction zone between the two belts and have the advantage that pressure is applied to a product when it is flat rather than when it is curved. The double band press also allows pressure to be adjusted over a wide range and the same is true of temperature variability. Dwell time or time under pressure also is controllable for a given press by varying the production speed or rate, as is capacity, which may be changed by varying speed and/or length and/or width of the press. Another advantage of the double band press is that the raw material may be heated first and then cooled, while the product is maintained under pressure. Heating and cooling elements may be separately located one after the other in line behind the belts. The steel press belts are first heated and then cooled, thereby efficiently heating and then cooling the material in the reaction zone and all while under pressure.

Continuous press machines, fitting the general description provided herein, are made by Hymmen GmbH of Bielefeld, Germany (U.S. office: Hymmen International, Inc. of Duluth, Ga.) as models ISR and HPL. These are double belt presses and also appear under such trademarks as ISOPRESS and ISOROLL. Typically they have been used to produce relatively thick laminates, primarily for the furniture industry, but have also been used to form polymer materials for use in the luggage industry, for example. Prior to the '295 invention they had not been considered for use in making microstructured products.

The bands with embossing patterns formed therein as disclosed and claimed in the aforesaid '295 patent had microstructured surfaces for forming the desired structure in the product passing through the press. These surfaces were either proposed to be the direct bands placed on the machine, or in one (or more) overlay band that was to be a continuous band placed over the regular smooth band(s) of the press.

In all the prior art versions of microstructured embossing noted above the metal embossing tools must be replaced at intervals, therefore a more efficient and effective method and apparatus for forming rigid panels with a microstructured surface has been invented.

While the apparatus disclosed in the '295 patent will work, it is neither cost effective nor an efficient way to produce rigid panels having a microstructured surface on one face, such as used in solar panels or roadway signs. In the first instance the thin film, after formation from the press, must be relocated to a different assembly station, where an adhesive is applied and a relatively rigid substrate panel adhered and then cured. This is both time consuming and labor intensive.

Secondly, and perhaps most importantly, the cost in time and labor to make the large belts required under the '295 patent also renders the film production inefficient and more costly. Over time in the prior art machines it was observed that the thin belts both lose some element of accuracy and also suffer some “creep” which, in the case of solar panels requiring light to be focused on a designated area, can render the panels less efficient. The longer the belt, such as disclosed in the '295 patent, the more exacerbated this problem becomes.

As described in the '295 patent, to provide the necessary formed belts or overlay tools that would fit on the Hymmen press, a belt having a perimeter of 419″ (1247 cm) was produced. In that case the belt also was 29.53″ (75 cm) wide. Not only is such a large belt unwieldy, the number of steps and complexity of formation of each such large belt is very time consuming and expensive as can be appreciated by the description of assembly in the '295 patent. Further, to preserve accuracy of the finished film, tracking elements for the large belts are required on the press, and the large belt makes tracking more complex. Finally, in embossing a thicker film, such as used in solar panels or for traffic signs, it is more difficult to separate the finished film continuously from a moving belt. The peel angle is difficult when having to remove a film from facets that have a low draft angle, as frequently found in solar panel designs. Moreover, as these large belts must be replaced with some regularity, the '295 apparatus using the continuous band tool, is not commercially practical.

Thus a primary object of the present invention is to provide a process and apparatus for efficiently, effectively, and inexpensively embossing thermoplastic materials with precise microstructure detail into a relatively rigid panel and at relatively high speeds.

For purposes hereof, a relatively rigid panel is a panel that, while it may have some degree of flexibility, it is sufficiently self supporting to be considered as a structural unit without any additional material laminated or adhered to it to render it functional for mounting. This does not preclude additional layers being adhered to the formed panel as part of a mounted structure, or to form a more complex multilayer object, it being the intent that the current manufacturing steps of adhering a thin film to a thicker substrate by lamination or otherwise to provide structural integrity will have been eliminated.

Also in considering the phrase relatively rigid or rigid herein the panel stiffness may depend both on the thickness and elasticity modulus of the material to be embossed and wherein the thickness or rigidity is so stiff it would not permit continuous embossing off a roll of supply material.

The present invention not only obviates the problems caused by large belts with microstructured surfaces, as suggested by the '295 patent, because it eliminates overlay bands or providing the microstructured surface on the continuous bands of the press, it also speeds up production of finished rigid solar or highway sign panels by eliminating a number of other manufacturing steps.

These advantages are accomplished by providing individual tool elements that match the panel to be formed and to serially feed the tool/panel combination into the double band press, minimizing the cost/time to prepare large continuous bands and the extended down time in changing the bands as they creep or lose accuracy and by directly embossing the rigid panel the subsequent current thin film production and then laminating steps are obviated.

### OBJECTS OF THE INVENTION

It is a primary object of the invention to provide a process for forming thermoplastic products having precision microstructured surfaces, comprising the steps of: providing a continuous press having opposed parallel continuous bands having upper and lower press surfaces defining a relatively flat reaction zone therebetween; serially feeding individual tools, each having a defined microstructured array thereon and a rigid thermoplastic material as a panel having one face juxtaposed with the tool surface, between the bands and through the reaction zone; and causing at least one surface of the panel material to be heated to its embossing temperature Tₑ while applying pressure to at least one press surface to form the precise microstructure surface in the panel as it moves through the reaction zone; and moving the tool and embossed panel to an adjacent area of the reaction zone and cooling the tool and embossed panel while concurrently maintaining pressure on the panel.

Another object of invention is to provide an apparatus for continuously forming thermoplastic products having precision microstructured surfaces thereon, comprising a continuous double band press having spaced upper and lower primary bands, means are provided for serially feeding individual tool elements having the desired microstructured surface formed thereon and juxtaposed with a relatively rigid panel of a thermoplastic material through the press and between the bands. Heating means are provided for heating the tool and thus at least one surface of the panel to its embossing temperature Tₑ; as are pressure means for applying sufficient pressure to the belts to cause the precise engagement of the heated thermoplastic panel with the belts and the tool surface to emboss the material with the precise microstructured pattern. The apparatus has cooling means for cooling the tool and the embossed panel while maintaining pressure on the panel while it is cooled, and while it is moving through the press.

As noted, the present invention offers numerous advantages and relates to a process and apparatus for making thermoplastic products having precision microstructured patterns in a relatively rigid material, comprising the steps of providing a continuous press with an upper set of rollers, a lower set of rollers, an upper belt disposed about the upper set of rollers, a lower belt disposed about the lower set of rollers, the upper and lower belts defining a relatively flat reaction zone therebetween, the reaction zone including a heating station, a cooling station and pressure producing means; feeding a metallic tool having the inverse of the desired microstructured form juxtaposed with a relatively rigid polymeric panel between the bands and through the reaction zone; heating the tool and at least the juxtaposed surface of the panel to an embossing temperature Tₑ above the glass transition temperature T_{g} of the thermoplastic material, (e.g. around 100° to 150° F./38° C. to 66° C. above T_{g}); applying an elevated embossing pressure to the panel, (e.g. about 250 psi/1.7 MPa); cooling the panel (e.g. well below T_{g}); while maintaining the elevated pressure on the panel.

The present invention adapts a known type of continuous machine press, known as an isobaric double band continuous press, to the embossing of precision microstructured thermoplastic panels. As noted, one well-known type of precision microstructured sheeting is optical sheeting. Flatness and angular accuracy are important in precision optical sheeting including, for example, cube corner retroreflective films for road reflectors or signage, and Fresnel lenses incorporating catadioptrics for solar panels. For purposes of this application, the term “panel” is used to describe any relatively rigid polymeric material having a predetermined size and shape and thickness into which the microstructured surface is to be formed on at least one side of the panel. The term is not to be limited by size or shape or intended use of the panel, or the particular polymer of which it is formed. Moreover, while the preferred tools used are metallic, a tool formed of a much higher melt point than the panel material may be used. In a preferred embodiment of the invention the feeding, heating and removal of the tools and panels is automated to a great degree to further enhance machine capacity.

Besides precision optical sheeting for use in solar panels, various other applications have been developed requiring the formation of highly precise shapes and structures in resinous optical film. In particular the invention permits the embossing of thermoplastic material to provide precision microstructures comprising microscopic embossed elements of elements, or arrays of microscopic recessed and/or raised embossed element having applications to optical, micro-fluidic, micro-electrical, micro-acoustic, and/or micro-mechanical fields. It would be particularly useful in forming large microprismatic panels for use as traffic signs.

As used in the present application, “precision microstructured” material generally refers to a resinous polymer material having an embossed precise geometric pattern of very small elements or shapes, and in which the precision of the formation is essential to functionality of the product. In this instance the precision of the embossed panel is a function of both the precise geometry required of the product, and the capability of the embossing tool, process and apparatus to conserve the geometric integrity from tool to article formed in the panel (on one or both sides thereof):
(a) flat surfaces with angular slopes controlled to a tolerance of 5 minutes relative to a reference value, more preferably a tolerance of 2 minutes relative to a reference value; or to at least 99.9% of the specified value;
(b) having precisely formed (often, very smooth) surfaces with a roughness of less than 100 Angstroms rms relative to a reference surface, more preferably with a roughness configuration closely matching that of less than 50 Angstroms rms relative to a reference surface; or, if the surface requires small irregularities it may be greater than 100 Angstroms and less than 0.00004 inch (1 micron);
(c) having angular acute features with an edge radius and/or corner radius of curvature of less than 0.001 inches (25 microns) and controlled to less than 0.1% of deviation;
(d) having an embossing depth less than 0.040 inches (1000 microns), more preferably less than 0.010 inch (250 microns);
(e) precisely controlled dimensions within the plane of the sheeting, in terms of the configuration of individual elements, and/or the location of multiple elements relative to each other or a reference point; and
(f) characteristic length scale (depth, width, and height) less than 0.040 inch (one millimeter) with an accuracy that is better than 0.1 percent.

In certain embodiments of precision microstructured panel, discrete elements and/or arrays of elements may be defined as embossed recessed regions, or embossed raised regions, or combinations of embossed recessed and raised regions, relative to the unembossed regions of the panel. In other embodiments, all or portions of the precision microstructured panel may be continuously embossed with patterns of varying depths comprising elements with the characteristics described above. Typically, the discrete elements or arrays of elements are arranged in a repetitive pattern; but the invention also encompasses non-repetitive arrays of precision microstructured shapes.

Exemplary types of precision microstructured panels, and their requirements of precision, include:

Retroreflective materials for road reflectors or signage; and Fresnel lenses for optical solar array applications. In each instance precise flatness, angles and uniform detail are important. Cube-corner type reflectors, to retain their functionality of reflecting light back generally to its source, require that the three reflective faces of the cube be maintained flat and within several minutes of 90° relative to each other. Spreads beyond this, or unevenness in the faces, results in significant light spread and a drop in intensity at the location desired. Also, surface smoothness is required so light is not diffused.

Feature to feature accuracy for LCD display systems and for solar panels in which adjacent embossed recesses not only have to be precisely shaped, the spatial relations of the array of recesses also must be closely adhered to.

The ability to manufacture microstructures with an edge radius of less than 0.001 inches (25 microns) and with very sharp points and sharp ridges (less than 0.00028 inches (7 microns).

Volumetric accuracy for microfluidic and microwell applications with 90% or greater accuracy of the cross sectional area being conserved through the length of channel; and from channel to channel, and/or well to well, in which dimensions range from 0.00020 to 0.008 inches (5-200 microns) depth; 0.00020 inches to 10 inches (5 microns to 25.4 cm). The channels may have convoluted shapes and microtextured shapes.

Surface roughness for microfluidic applications that allow for low friction and minimal surface drag, all resulting in smooth continuous non-diffusive flow, allowing the fluid flowing laminar.

The avoidance of residual stresses by providing essentially stress free microstructures. This is critical for some optical, FSA, and for microfluidic applications were the detection mechanisms uses fluorescent polarization technology. Materials with stress generally have strand orientation, which acts like a polarizing lens. Materials that contain residual stresses may relax that stress during subsequent processing or during the life cycle of the product, resulting in dimensional instability.

For Fresnel lenses, either radial or lenticular.

The precision microstructured pattern typically is a predetermined geometric pattern that is replicated from the tool. It is for this reason that the tools of the preferred embodiment are produced from electroformed masters that permit the creation of precisely designed structures.

A more complete understanding of the present invention and other objects, aspects, aims and advantages thereof will be gained from a consideration of the following description of the preferred embodiments read in conjunction with the accompanying drawings provided herein.

### BRIEF DESCRIPTION OF THE DRAWINGS

FIG. 1A is a perspective view of a tool for embossing a solar panel in accordance with the present invention;

FIG. 1B is a side elevation view of the tool of FIG. 1A;

FIG. 1C is a typical Fresnel lens forming part of the panel lens array of the tool of FIG. 1A;

FIG. 1D is a perspective view of a tool for forming a rigid polymeric microprismatic traffic sign;

FIG. 1E is a side elevation of a rigid traffic sign panel formed by the tool of FIG. 1D, and having a protective backing layer positioned behind the prisms;

FIG. 2A is a diagrammatic elevation view of a double band press of the type contemplated for use in the present invention and depicting tools and panels passing through the press;

FIG. 2B is diagrammatic isometric view of a double band press for embossing to provide precision microstructures polymer panels;

FIG. 3A is an elevation view of a “sandwich” consisting of the tool, a juxtaposed panel and a polymer overlay, as fed into the press;

FIG. 3B is an elevation view of the embossed panel with the film overlay on the top surface of the embossed panel;

FIG. 3C is an elevation view of a finished panel, similar to the tool of FIGS. 1A and 1B;

FIG. 3D is a perspective view of a finished solar panel; and

FIG. 4 is an illustrative form of one type of schematic layout for automatically assembling the panels, tools and overlay film, feeding into the press, cooling the embossed panel and removing the finished panel from the tool.

While the present invention is open to various modifications and alternative constructions, the preferred embodiments shown in the drawings will be described herein in detail. It is understood, however, that there is no intention to limit the invention to the particular form disclosed. On the contrary, the intention is to cover all modifications, equivalent structures and methods, and alternative constructions falling within the spirit and scope of the invention as expressed in the appended claims.

### DETAILED DESCRIPTION OF THE INVENTION

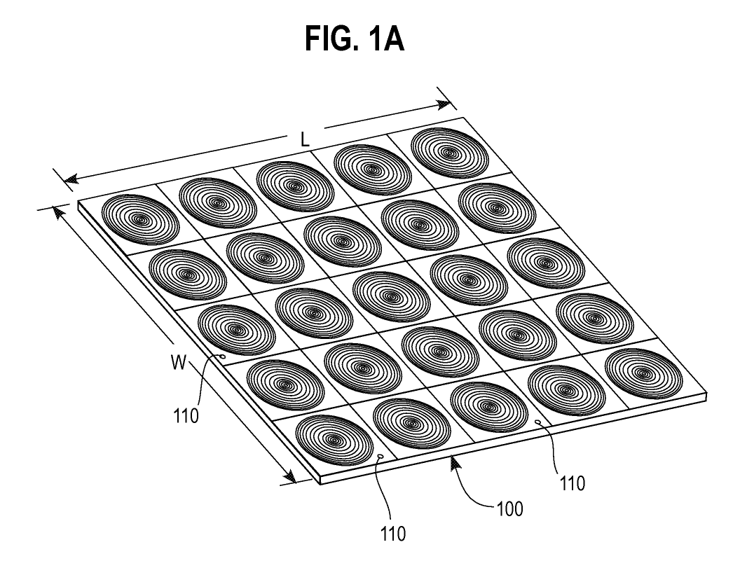

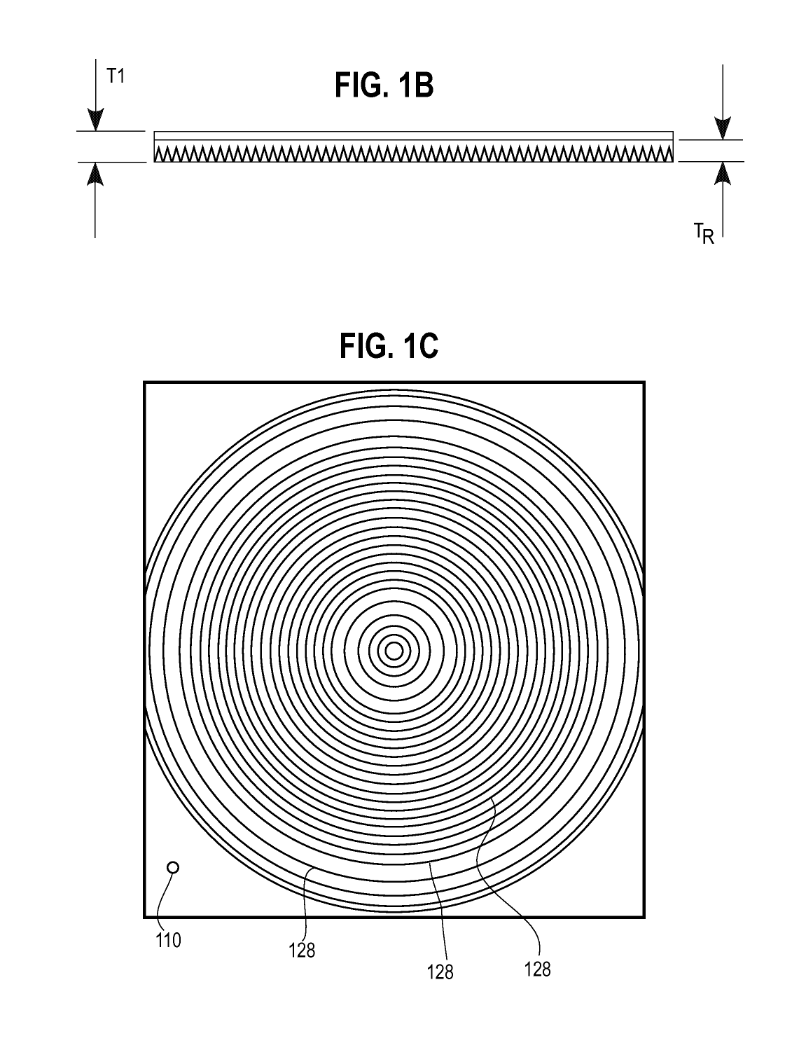

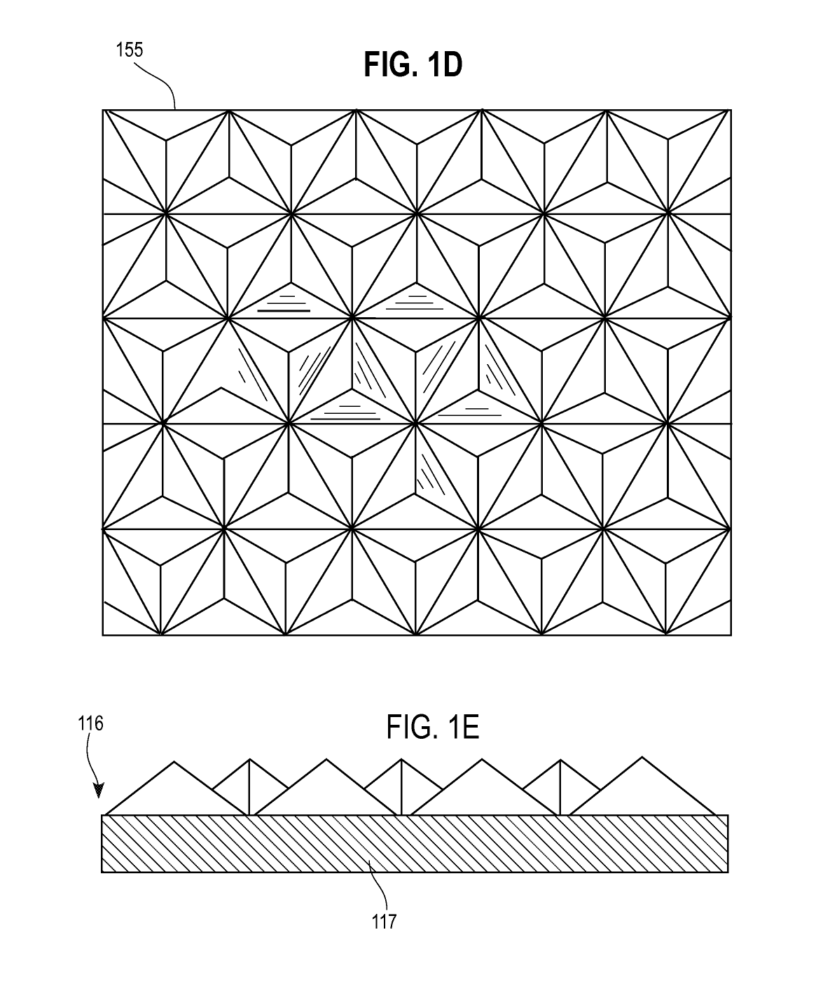

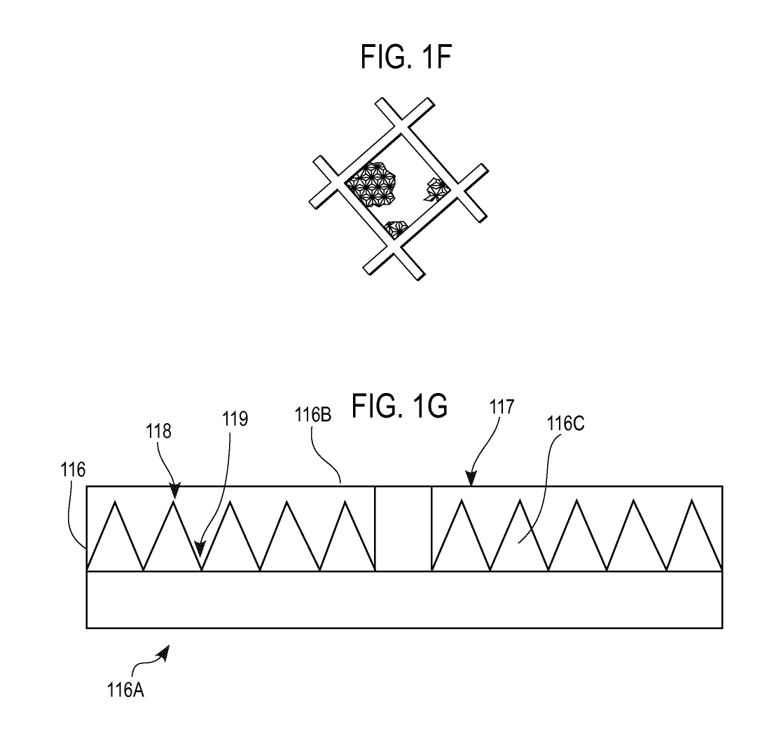

Referring now to FIG. 1A, there is depicted a tool 100 for use in the press hereinafter described. As an example, the tool 100 depicted here may be for the production of a solar panel, and consequently the tool 100 has an array of Fresnel lenses 110 which have been laser welded together to form the complete array.

The tool in this case may be 39.37″ (1 M) in both length L and width W, and may have six or more rows of lenses 110 in each direction depending on the lens and panel sizes required by the customer. In some instances small flat areas may be provided between rows of lenses to facilitate later mounting of a completed panel to a frame for mounting in a much larger rotatable structure. As best seen in FIG. 1B, the tool 100 has a total thickness of about 0.020 inches (0.05 CM) and the essentially recessed grooves which will form the complementary grooves which make up the Fresnel lens structure which typically range from 0.0002 inches (0.0005 CM) to 0.010 inches (0.025 CM) below the nominal plane of the tool.

The tool 100 may be formed by first diamond cutting a master lens for the pattern generally depicted in FIG. 1C, and then replicating this by electroforming nickel many times, and then assembling the lenses 110 by laser welding into the final size required for the finished tool. In this instance the radial Fresnel lens has facets with slope angles that change as the distance from the optical axis increases. The draft angle is typically 1.5 degrees. It will be understood that this is one example of design of a tool for a rigid panel that may be produced; other panels with different microstructures and for different purposes will have different dimensions and patterns. A detailed explanation for making tools for embossing microstructured parts is found in the prior art patents cited hereinabove and the method of making the tool forms no part of the present invention.

Referring now to FIG. 1D, a tool 155 for forming a rigid microprismatic polymeric traffic sign panel 116, having a thickness no less that 2.5 mm, and preferably 3 mm, is depicted together with a thin backing layer 117, of the same or another polymer, later applied, as by sonic welding or adhesives. This rear layer provides protection from dirt and the like building up and causing the cube corner prisms to have diminished effectiveness.

In FIG. 1E a formed polymer panel 116 is shown, as having a preferred overall thickness “T of 3.0 mm. The panel 116 has front and rear faces 116A and 116B, and the cube corner microprisms 116C have been formed in the rear face. In this case, the microprismatic prisms will range in depth from the prism apex 118 to the bottom valley 119 depending on prism design. This height and also the other dimensions of the cube corners will vary, depending upon the nature of the precise cube-corner shaped prism to be formed. In recent years for example film of non-triangular cube corner prisms (looking at a cube corner along the normal to the panel) have been manufactured by various means. The particular shape and dimensions of the cube corner is not germane here, as the cube corners would be designed to meet various regulatory highway specifications. The rigid polymeric sign panel produced by the present invention can accommodate various geometrically formed cube elements as may be provided in the tool 115. Similarly, resinous polymers used for highway signs may be processed according to the invention to produce the rigid panels.

Because of the advantages of the present process, it is possible to form a rigid polymeric microprismatic traffic sign panel in a manner that will eliminate the need for the typical aluminum backing member which is normally used to provide rigidity to the thin films heretofore used. This may result in a cost savings to the customer of as much as 35-40% based on elimination of an expensive material (aluminum) and the extra labor and handling involved in applying the film to the aluminum panel.

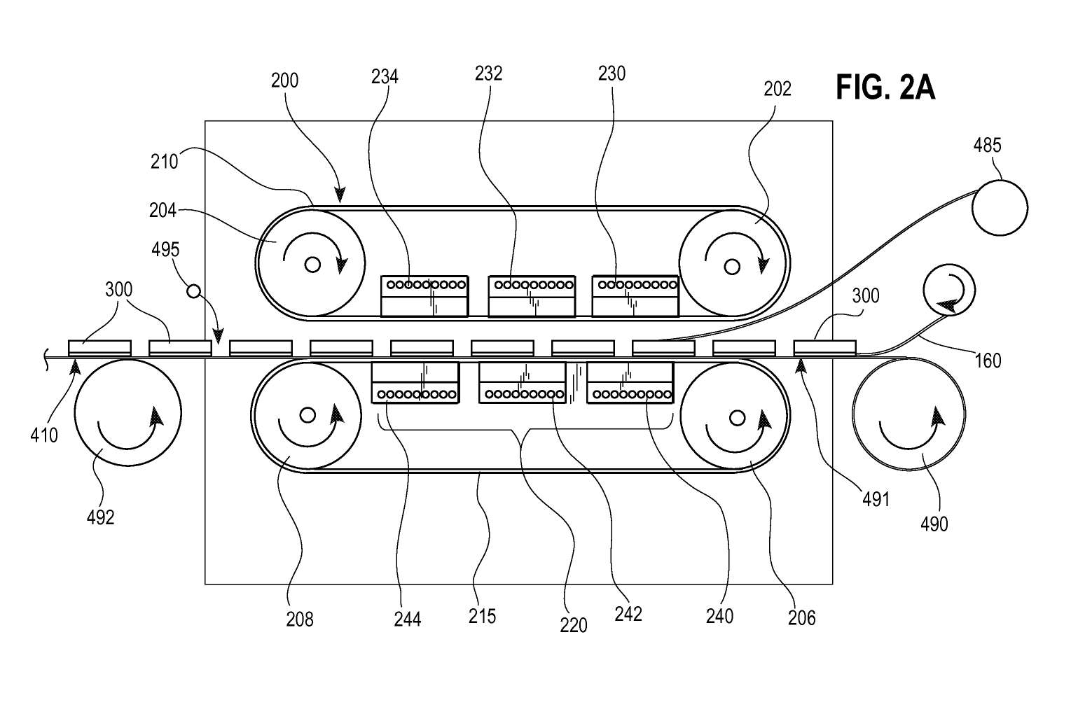

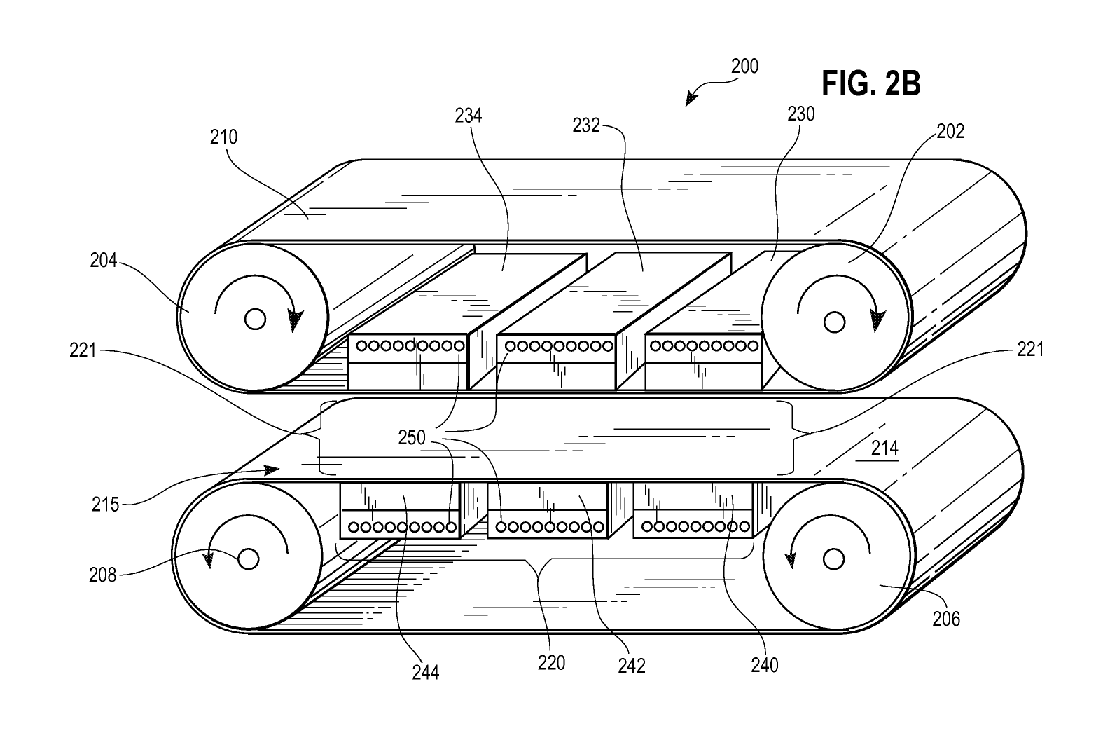

Referring now to FIGS. 2A and 2B, a continuous press 200 is diagrammatically illustrated. The press 200 includes a pair of upper rollers 202, 204 and a pair of lower rollers 206, 208. The upper roller 202 and the lower roller 206 may be oil heated. Typically the rollers are about 31.5 inches (80 cm) in diameter and extend for a width of about 51 inches (130 cm). Around each pair of rollers is a highly polished belt, typically of steel.

An upper plain surfaced belt 210 is mounted around the upper rollers 202, 204 and a lower plain surfaced belt 215 is mounted around the lower rollers 206, 208. The direction of rotation of the drums or rollers, and thus the belts or bands 210 and 215, is shown by the curved arrows in FIG. 2B. Heat and pressure are applied in a portion of the press 200 referred to as the reaction zone 220, also defined between the bands by the brackets 221. Within the reaction zone are means for applying pressure and heat, such as three (or more) upper matched pressure sections 230, 232, 234 and three lower matched pressure sections 240, 242, 244. On one version of this equipment, the area to be embossed under the belts would accommodate a panel one meter long and 56″ wide. Heat and pressure may be applied by other means as is well known by those skilled in the press art. Also, it is understood that the dimensions set forth are for existing continuous presses, such as those manufactured by Hymmen; these dimensions may be changed if found desirable to add flexibility as to the size/shape of finished panels desired.

It is to be understood that each of the pressure sections may be heated or cooled; i.e., the temperature of each press section can be independently controlled, which is particularly advantageous as will be later explained. Thus, for example, the first two upstream pressure sections, upper sections 230, 232 and the first two lower sections 240, 242 may be heated whereas the downstream sections 234 and 244 may be cooled or maintained as a relatively constant but lower temperature than the upstream heated sections. Further, each of the upper and lower sections of a pair also may be controlled to a different temperature. It will be observed from FIGS. 2A and 2B that each of the pressure sections may have provisions for circulating heating or cooling fluids therethrough, as represented by the circular openings 250.

The upper surface 214 of lower belt 215 may be smooth to facilitate movement of the carrier material for the tool/panel/overlay stack (hereinafter described as the “sandwich”), as it moves through the press 200.

When embossing thicker panels, it is desirable to have the lower belt section operate at a much higher temperature than the upper section (unless embossing is to take place on both sides of the panel), as it is undesirable to heat the entire panel to above its melting point. Thus having a temperature gradient from high temperature at the embossing surface to much lower temperature at the opposite panel surface during embossing accelerates cooling of the embossed panel thereby accelerating removal time of the finished panel from the tool.

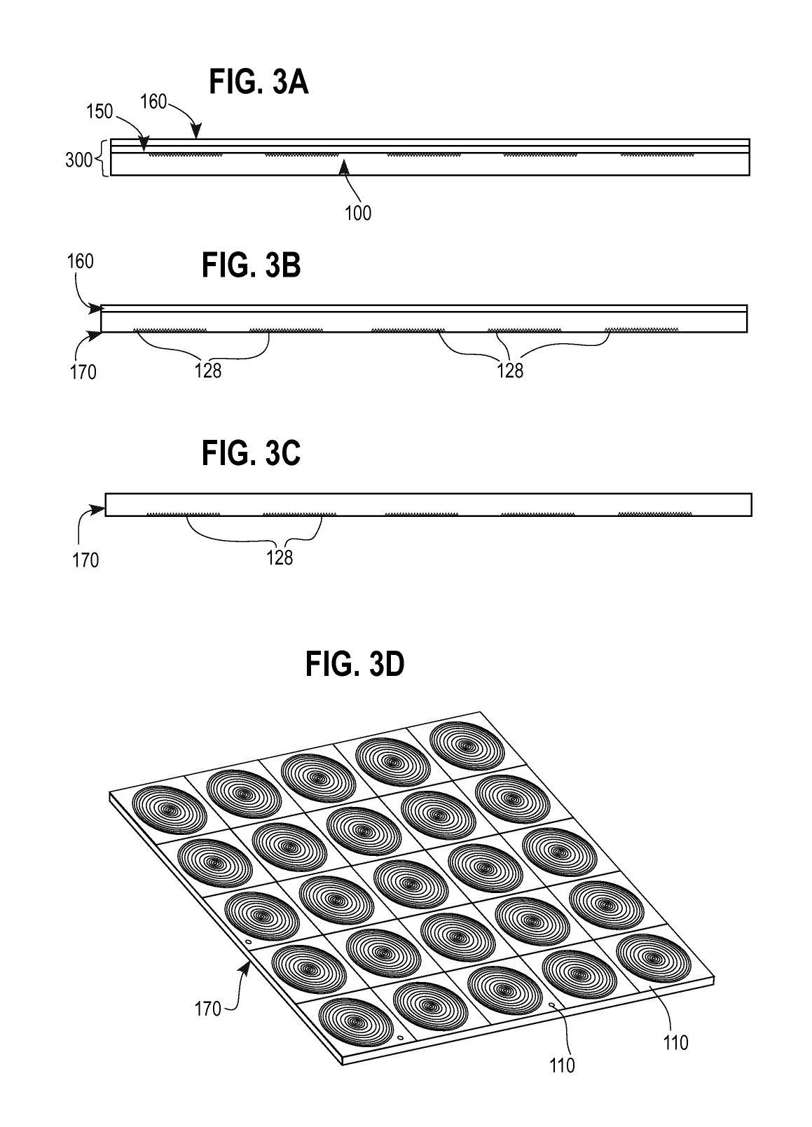

The process for embossing the relatively rigid polymer panel 150 to precise microstructure formation consists of feeding a sandwich 300 (FIG. 3A) which comprises a tool 100, a rigid polymer panel 150 in close juxtaposition therewith, and a Mylar (PET) overlay 160, into the press 200; heating the tool 100 and at least the lower surface area of the panel 150 to an embossing temperature Tₑ above the glass transition temperature T_{g} (e.g. about 100° F. to 150° F./38° C. to 66° C. above that glass transition temperature); applying pressure of about 300-700 psi/20-48 bar/2.06-4.83 MPa (e.g. 450 psi/30 bar/3.1 MPa) to the sandwich 300; cooling the embossed panel at the cooling station which can be maintained below ambient temperature (e.g. at about 72° F.; 22° C.) and maintaining a pressure of about 300-700 psi/20-48 bar/2.06-4.83 MPa (e.g. about 450 psi/30 bar/3.1 MPa) on the sandwich 300 during the cooling step.

In one set of experimental runs, panels of PMMA having a thickness of 3 mm and length and width of 1.5 m by 0.990 m, coupled with a nickel tool 100 and having thirty Fresnel lenses in the array, were passed through a press 200 of the type described. Pressure in the ranges of 30 to 40 bar were found satisfactory with the best result at 40 bar. The temperature changes between upper and lower stations may have varied between 210° C. for the upper section 230 and 210° C. for the lower section 240, and temperatures of 70° C. for the second station and 20° C. at the third station where cooling was taking place. Various combinations of temperature, speed and pressure may be utilized depending upon the desired finish and the thickness of the panel to be embossed.

With the dimensions and reaction zones stated above, the process rate by serially feeding sandwiches into the press may move at about 7.5 to 10 feet (2.5 to 3.5 meters) per minute. Even though the experiment was limited by having to manually feed sandwiches 300 into the press the rate of speed was much greater than the rate of existing prior art machines, which for a 0.5 mm thick film used for example in solar panels runs at 0.66 meters per minute and are then laminated, to 3 (mm) sheet, at an average rate of 1.3 meters/minute the average speed of the two operations is 0.98 meters per minute.

After passing through the press 200 and being sufficiently cooled, the tool 100 and formed panel (now designated 170 in FIGS. 3B-D) are separated. The panel 170 may retain the Mylar overlay 160 until the panel is ready to be used, thus protecting the upper surface of the panel 170 during shipping or other assembly. The overlay 160 can be easily peeled from the panel 170.

The overlay also assures that the upper surface of the panel 150 as it moves through the press will have a smooth unblemished surface that will not pick up any of the graininess in the steel bands, no matter how well polished. Where the panel 170 is comprised primarily of PMMA, than the overlay material may be of Mylar. Other combinations of course are likely.

For a given size embossing tool and panel, and press machine, the embossing goal is to maximize production. Other things being equal, the design that uses more of the press belt's width and length is better. Length might be used for forming or for cooling. At the maximum running speed, these two minimum times (forming and cooling) occupy all the available length. The minimum time (length) required for forming may be less than, equal to, or greater than the minimum time (length) required for cooling. The present equipment permits some variation of these distances by virtue of the pressure plate arrangements. Additional pre-heating of the tool and panel before entry to the reaction zone, or post-reaction zone cooling also may be provided, depending on the materials and thicknesses used. It may also be desirable to temporarily connect adjacent tools as they run through the press to both minimize damage to the belts (by avoiding discontinuity gaps as pressure is applied) and disconnecting the adjacent tools as they exit the press.

In isobaric double band presses such as that of Hymmen GmbH, the bands serve to seal in the pressurized fluid (oil or air), which can be under an elevated pressure as great as 1000 psi/68 bar/6.8 MPa). This requires that the belt have adequate mechanical strength (tensile strength and yield strength) to withstand the high pressures.

The reaction zone 220 is formed between the lower run of the upper press band 210 and the upper run of the lower press band 215 in which the material panel is fed, which in this case was a synthetic thermoplastic resin.

The reaction zone pressure can be applied hydraulically to the inner surfaces of the endless press belts 210 and 215 by the opposing pressure plates 230, 232, 234, and 240, 242, 244 and is transferred from the belts to the sandwich 300 fed therebetween (see FIG. 2A). Reversing drums or rollers 202 and 206 arranged at the input side of the press are heated and, in turn, heat press belts 210 and 215. The heat is transmitted through the belts into the reaction zone where it is supplied to the film material. Similarly, the opposite reversing drums 204 and 208 may be arranged for additional cooling of the belts.

The pressing force is provided on the sandwich 300 in the reaction zone 220, 221 by a fluid pressure medium introduced into the space between the upper and lower pressure plates and the adjacent inside surfaces of the press belts located between the rollers, which portions of the belts form the reaction zone. The space forming the so-called pressure chamber (exemplified for the lower belt as 260) is defined laterally by sliding seals. In order to avoid contamination of the panel 150, desirably compressed air or other gases (as opposed to liquids) are used as the pressure medium in the pressure chamber of the reaction zone.

As the continuous press includes polished and plain surfaced bands, a very smooth surface finish is required that may be provided for example using a polished chrome surface of a stainless steel band. In the case of the Hymmen isobaric press, a surface finish of 0.00008-0.00016 inches (2-4 micron) R_{z} is desired, which is equivalent to 80-160 microinch rms in English units. Cf. American National Standards Institute, “Surface Finish”, ANSI B46.1. Surface treatment techniques such as polishing, electropolishing, superfinishing and liquid honing, can be used to provide the highly smooth surface finishes of belts 210, 215.

Considering now the resinous panel material in greater detail; for purposes of the present invention, two temperature reference points are used: T_{g} and Tₑ.

T_{g} is defined as the glass transition temperature, at which plastic material will change from the glassy state to the rubbery state. It may comprise a range before the material may actually flow.

Tₑ is defined as the embossing or flow temperature where the material flows enough to be permanently deformed by the continuous press of the present invention, and will, upon cooling, retain form and shape that matches or has a controlled variation (e.g. with shrinkage) of the embossed shape. Because Tₑ will vary from material to material and also will depend on the thickness of the panel material and the nature of the dynamics of the continuous press, the exact Tₑ temperature is related to conditions including the embossing pressure(s); the temperature input of the continuous press and the press speed, as well as the extent of both the heating and cooling sections in the reaction zone, both at the upper and lower levels of the press elements.

The embossing temperature must be high enough to exceed the glass transition temperature T_{g}, so that adequate flow of the material can be achieved to provide highly accurate embossing of the film by the continuous press.

Numerous thermoplastic materials may be considered as polymeric materials to provide precision microstructure panels. Applicant has experience with a variety of thermoplastic materials to be used in embossing under pressure at elevated temperatures. These materials include thermoplastics of a relatively low glass transition temperature (up to 302° F./150° C.), as well as materials of a higher glass transition temperature (above 302° F./150° C.).

Typical lower glass transition temperature (i.e. with glass transition temperatures up to 302° F./150° C.) include materials used for example to emboss cube corner sheeting or Fresnel lenses for solar panels, such as vinyl, polymethyl methyacrylate (PMMA or Acrylic), low T_{g} polycarbonate, polyurethane, and acrylonitrile butadiene styrene (ABS). The glass transition T_{g} temperatures for such materials are 158° F., 212° F., 302° F., and 140° to 212° F. (272° C., 100° C., 150° C., and 60° to 100° C.).

Higher glass transition temperature thermoplastic materials (i.e. with glass transition temperatures above 302° F./150° C.) which applicant's assignee has found suitable for embossing precision microstructures, may include polysulfone, polyarylate, cyclo-olefinic copolymer, high T_{g} polycarbonate, and polyether imide.

A table of exemplary thermoplastic materials, and their glass transition temperatures, appears below as Table I:

TABLE I

| Symbol | Polymer Chemical Name | T_{g} ° C. | T_{g} ° F. |
|---|---|---|---|
| PVC | Polyvinyl Chloride | 70 | 158 |
| Phenoxy | Phenoxy PKHH | 95 | 203 |
| PMMA | Polymethyl methacrylate | 100 | 212 |
| BPA-PC | Bisphenol-A Polycarbonate | 150 | 302 |
| COC | Cyclo-olefinic copolymer | 163 | 325 |
| Polysulfone | Polysulfone | 190 | 374 |
| Polyarylate | Polyarylate | 210 | 410 |
| | High T_{g} polycarbonate | 260 | 500 |
| PEIPI | Polyether imide | 260 | 500 |
| Polyurethane | Polyurethane | varies | varies |
| ABS | Acrylonitrile Butadiene Styrene | 60-100 | 140-212 |

The thermoplastic panel also may comprise a filled polymeric material, or composite, such as a microfiber filled polymer, and may comprise a multilayer material, such as a coextrudate of PMMA and BPA-PC.

A variety of thermoplastic materials such as those listed above in Table I may be used in the press 200 (or the other embodiments described). Relatively low T_{g} thermoplastic materials such as polymethyl methacrylate, ABS, polyurethane and low T_{g} polycarbonate may be used in the press 200. Additionally, relatively high T_{g} thermoplastic materials such as polysulfone, polyarylate, high T_{g} polycarbonate, polyetherimide, and copolymers also may be used in the press 200. Applicants have observed as a rule of thumb that for good fluidity of the molten thermoplastic material in the reaction (embossing) zone, the embossing temperature Tₑ should be at least 50° F. (10° C.), and advantageously between 100° F. to 150° F. (38° C. to 66° C.), above the glass transition temperature of the thermoplastic sheeting.

With such thermoplastic material the pressure range is approximately 150 to 700 psi (10.3 to 48 bar/1.03 to 4.82 MPa), and potentially higher, depending on factors such as the operational range of the continuous press; the mechanical strength of the embossing tool (high pressure capacity); and the thermoplastic material and thickness of the thermoplastic panel.

It may be desirable that the panel be cooled under low or no pressure, after being exposed to heat and pressure during the forming process, to minimize potential residual stress in the final product. Cooling under low or no pressure may differ from product to product. Thus, under some circumstances the cooling station will be maintained in the range of 35° F. to 41° F. (2° C. to 5° C.) and the pressure range approximately 150 to 200 psi (10.3 to 13.7 bar/1.03 to 1.37 MPa). The pressure in the reaction zone will be similar for heating and cooling.

The planar surface of products such as Fresnel lenses must have a surface roughness of 10-15 nm Ra or lower in order to have an acceptable range of light transmission through the lens. It has been determined that in order to adequately form the planar side of the product in a double belt press the belt on the planar side must also have a surface roughness in the range of Ra 10 to 15 nm or lower. Using other methods of replicating optical lenses such as hot polymer embossing the planar surface of the product is determined by the surface roughness of the carrier film such as optical grade PET. As an example the polymer in a hot polymer embossing process is heated to a temperature above the Tg while in contact with the PET carrier and is then cooled below the Tg so the new surface roughness of the planar surface is determined by the surface roughness of the PET. It is therefore required the surface roughness of the upper belt in the double belt press be 10-15 nm or less surface roughness.

Thermoplastic materials of thicknesses of up to 0.250 inches (6.35 mm) may be embossed with precise formations in the range of 0.0004 to 0.010 inches (0.1 to 250 microns) deep.

The apparatus of the present invention allows for the thermoplastic panel to be relatively thick and yet still have precision microstructures in one or both major surfaces. This allows products as diverse as solar panels, office light diffusers, reflective signage, compact disks, flat panel displays, high-efficiency lighting systems for internally illuminated signs and medical diagnostic products to be efficiently, effectively and inexpensively manufactured. Another exemplary application is retroreflective lenses for road markers, which are more than 0.04 inches (1 mm) thick. The embossing is on the order of 0.006 inches (0.15 mm) deep.

In embossing relatively thick thermoplastic panels, the apparatus of the invention can emboss both sides of the sheeting without heating the center. This can be accomplished using a sandwich of a panel juxtaposed between two tools, and with no overlay. Besides double sided embossing of a monolayer material, the embossing process of the invention permits the embossing of two polymer layers separated by a separator sheet, which are later stripped apart; an example is a sandwich of PMMA, PET, and PMMA films.

The use of the phrase polymer in the appended claims is intended to cover all of the foregoing possibilities—single layer panels; laminates; use of a strippable carrier and registered and unregistered embossing.

A typical Fresnel lens pattern for a solar panel 170 with lens groove elements 128 formed with the aid of the embossing tool 100 such as that depicted in FIG. 1A is illustrated. Shown in FIG. 1C (which is the tool, but the embossed lens will be complementary), the lens pattern so formed on panel 150 would have on one surface multiple groove elements 128 having a depth illustrated, for example, may be 0.00338 inch (85.85 microns and the distance between parallel grooves, which for the depth dimension above is provided, would be about 0.0072 inch (189 microns) It will be understood, of course, that these dimensions may vary but they tend to be generally within a fairly narrow but precise range. Similarly, the dihedral angles forming the groove faces are accurate within two minutes of the desired dihedral angle.

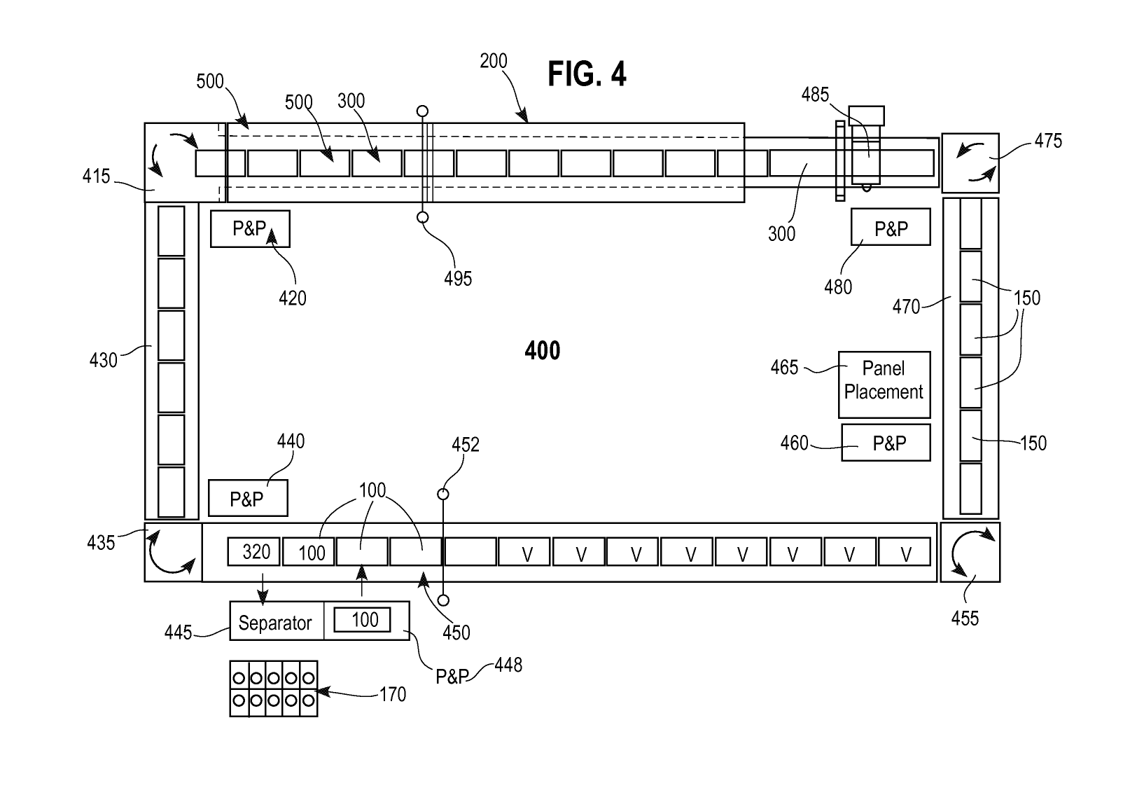

There is depicted in FIG. 4 (and partly in FIG. 2A), a schematic layout of an automated assembly process 400. Thus there is the press 200 through which the sandwiches 300 are fed. Because of the high level of pressure in the press, adjacent tool sandwiches need be close together to maintain press section alignment. If the equipment is down, dummy metal plates (not shown) of the size of the dimensions (width and length) of the tool and of the thickness of the sandwich 300 may be interposed between adjacent sandwiches to allow the press to operate continuously. In the present case a carrier material 491, which may be Mylar, is fed continuously from a supply roller 490 over a conveyor section and the tool sandwich 300 is placed over the carrier. Another roll of Mylar at 485 is placed over the line of tool/panel as they are fed into the press 200 to form the sandwich. A smoothing or nip roller (not shown) may be employed to assure that the Mylar properly lays down on the moving sandwiches as they move toward the press 200. As the embossed panel sandwich leaves the press 200 the carrier film 491 will be taken up by roller 492 while conveyor 410 continues to move the units 300 along. They pass through an additional cooling zone 500 (which may consist of chilled air fed into a housing), from there to a first index table 415 coupled with a pick and place unit 420 that moves the units 300 to the next conveyor 430. The now embossed units 300 continue to cool and approach a second combination index table 435 and pick and place unit 440 where they are directed to conveyor 450. As they move through this station a separator 445 removes the units 300 from conveyor 450. At the separator station 445 the embossed panel 170 and attached overlay 160 are pulled out of the system and separated from their respective tool 100. Adjacent is another pick and place unit 448 that introduces the empty tool 100 back onto the conveyor 450, where it moves to index table 455 and pick and place unit 460 to be laid onto conveyor 470. While on conveyor 450 the tool 100 also passes under a laser scanner 452 that reads the optics and spacing of the Fresnel configuration to assure that particular tool will continue to produce formed panels that meet optical specifications. If not the tool will be removed by a vacuum assisted suction device (not shown) and moved to storage for scrap recycle. Similarly a scan will be conducted of the embossed panel to assure that it meets the optical specifications. After indexing to conveyor 470 a panel placer 465 will put a new panel 150 on the adjacent tool, with optical devices assuring proper placement. At this point there may be some manual monitoring/adjustment to assure proper fit. The new partial sandwich moves to the next index table 475 and pick and place unit 480 where it is placed on to the carrier film 491 fed by drum 490 onto a conveyor (and where it may be temporarily connected to the preceeding tool) that then feeds the unit into press 200. As it approaches the press the film of Mylar is laid down over the moving units to complete the sandwich 300. As the finished units exits the press 200 a knife or laser 495 cuts through the Mylar overlay thus separating the finished units before they enter the cooling station 500.

The specification describes in detail several embodiments of the present invention. Other modifications and variations will, under the doctrine of equivalents, come within the scope of the appended claims. For example, presses having somewhat different geometries and/or different dimensions are considered equivalent structures. Different thermoplastic material may affect pressure and temperature as well as process speed. Further, different material densities and thicknesses may also affect the apparatus and process. There is no desire or intention here to limit in any way the application of the doctrine of equivalents.

1. A process for continuously forming relatively rigid polymeric panels each having precision microstructured surfaces on at least one side thereon, comprising the steps of:
providing a continuous double band press having upper and lower primary bands;
providing at least one tool separate from said bands, said tool being provided with a tool surface having the inverse topography of the precision microstructured surface to be formed on the panel;
juxtaposing a rigid polymeric panel on the microstructured surface of said tool;
feeding said tool with said panel thereon through said press and between said bands;
heating said tool and at least one side of said panel to the polymer embossing temperature Te;
applying sufficient pressure to said tool and said panel to cause the precise engagement of said heated polymer and said tool with said belts;
applying pressure to said heated tool and panel through said belts and said tool surface to emboss the material with said precise microstructured pattern;
cooling said embossed panel while maintaining pressure thereon and while said panel is moving through said press; and
removing said formed panel from said tool after they exit from said press.

2. The method according to claim 1, in which a second tool is provided on the opposite surface of said panel having the inverse topography of the structure to be formed on said second surface and wherein said second surface and second tool are heated to the embossing temperature of the polymer.

3. The method according to claim 1, wherein at least some of said heating step is conducted prior to said panel engaging said bands.

4. The method according to claim 1, wherein said heating step is at least partially conducted while said panel is moving through said bands.

5. The process of claim 1, wherein said panel is fed through said press at a rate of between about 21 (6.40) and about 32 (9.75) feet (meters) per minute.

6. The method according to claim 1, wherein during said heating step said material is brought to between the range of 250° F. to 750° F. (120° F. to 399° C.) and said pressure is about 150-1000 psi (1.03 MPa-6.89 MPa).

7. The method according to claim 1, wherein the cooling temperature is in the range of between about 35° F. to 75° F. (2° C. to 24° C.).

8. The method according to claim 1, wherein said panel consists of a plurality of thermoplastic materials.

9. The method of claim 1, and further comprising the step of providing a removable overlay material on the surface of said panel opposite that surface to be embossed, said overlay to assure a smooth surface to said one surface of said panel.

10. The method of claim 1, and further comprising the step of serially feeding a plurality of tools each having a panel thereon through said press.

11. An apparatus for continuously forming relatively rigid polymeric panels having precision microstructured surfaces on at least one side of such panel, comprising:
a continuous double band press having upper and lower primary bands providing a relatively planar region therebetween;
at least one tool being provided with a tool surface having the inverse topography of the precision microstructured surface to be formed in the associated panel;
means for feeding said tool with an associated panel juxtaposed thereon through said press and between said bands;
means for heating said tool and at least the surface of said panel adjacent to said tool to the embossing temperature Tₑ of said polymer;
means for applying sufficient pressure to said belts to cause the precise engagement of said heated polymeric with said belts and said tool surface to emboss the associated panel with said precise microstructured pattern; and
means for cooling said associated embossed panel while maintaining pressure on said panel, and while said panel is moving through said press.

12. The apparatus of claim 11, wherein said pressure producing means is provided a range of 250 to 1000 psi (1.72 MPa to 6.89 MPa).

13. The apparatus of claim 11, wherein said heating means is capable of heating said panel within a range of 250° to 750° F. (121° C. to 399° C.).

14. The apparatus of claim 11, wherein said bands are operated such that said panel is fed through said press at a rate of between about 21 (6.40) and about 32 (9.75) feet (meters) per minute.

15. The apparatus of claim 11, wherein said heating means combining said material to between the range of 250° to 580° F. (121° C. to 304° C.) and said pressure is about 150-1000 psi (1.03 0 6.89 MPa).

16. The apparatus according to claim 11, wherein said cooling means is in the range of between about 35° to 75° F. (2° C. to 24° C.).

17. The apparatus according to claim 11, wherein said microstructure pattern on said tool includes at least a portion for forming an array of precise geometric recessed profiles, each recess having a depth of 0.01 inches (250 microns) or less;

18. The apparatus according to claim 11, wherein the heating and pressure applying means comprise at least two stations along the path defined by said belts.

19. The apparatus according to claim 11, wherein each of said stations includes a segment above and below the upper and lower primary bands, and wherein each of said segments can be controlled to provide different temperatures above and below the tool and associated panel as they move through said press.

20. The method according to claim 1, and further including the step of controlling the heating of said tool and associated panel to different temperature levels from above and below the tool, whereby the upper surface of said panel never reaches its glass transition temperature, while the lower surface of said panel reaches its embossing temperature.

21. A unitary relatively rigid retroreflective highway sign panel having front and rear faces comprising a polymeric material having an array of microprismatic retroreflective elements integrally formed on the rear face of said panel, and wherein said panel has a thickness no less than 2.5 mm.

22. The highway sign panel of claim 21 and wherein said panel has a thickness of about 3.0 mm.

23. The highway sign panel of claim 21, and further including a backing layer adhered to said rear face and overlying said microprismatic elements.
